(19) United States
(12) Patent Application Publication
(10) Pub. No.: US 2006/0020519 A1
(43) Pub. Date: Jan. 26, 2006

(54) System and method for automatically updating business information reports

(75) Inventors: Scott W. Schroeder, Maplewood, NJ (US); John R. Stewart, Elizabeth, NJ (US); Ruth J. Davis, Montclair, NJ (US); Timothy R. Letteer, Jersey City, NJ (US); Suneet K. Bhatt, Jersey City, NJ (US); Kathy Reynard, Easton, PA (US)

Correspondence Address: Paul D. Greeley, Esq.;Ohland, Greeley, Ruggiero & Perle, L.L.P., 10th Floor, One Landmark Square, Stamford, CT, 06901-2682, US

(73) Assignee: DUN & BRADSTREET, INC.

(21) Appl. No.: 11/043,762

(22) Filed: Jan. 26, 2005

Related U.S. Application Data
(60) Provisional application No. 60/540,435, filed on Jan. 30, 2004.

(51) Int. Cl. G06Q 30/00; G06Q 40/00

(52) U.S. Cl. 705/26; 705/35

(57) ABSTRACT

The invention includes methods, systems, and computer-readable media that provide an automatically updated business information report to a customer by performing steps including updating daily a database of business information with newly available business information that is more current than that present in the database, generating a business information report in dependence on data retrieved from the database, storing the generated business information report for customer access, updating the business information report with data retrieved from the database that is more current than that presently contained in the business information report; the updating occurring upon each access of the business information report by the customer; and storing the automatically-updated business information report for further customer access.

This application claims the benefit of U.S. provisional patent application Ser. No. 60/540,435 filed Jan. 30, 2004.

### BACKGROUND OF THE INVENTION

1. Field of the Invention

The present disclosure generally relates to providing current business information. In particular, the present disclosure relates to providing a service for automatically updating business information reports that are purchased from a website, including selling, marketing, and delivering this service.

2. Background of the Invention

Business information reports have been offered to customers as either a one-time purchase of a static report or as part of a subscription package for a period of time. Business information reports are generally used to make business decisions, such as whether to extend credit, choosing suppliers, determining how much credit to extend, and other business decisions. Customers desire the most current business information as a basis for these business decisions. If a customer purchases a static report that is no longer current, the customer must buy another report for the same price without knowing whether much has changed. If a customer has a subscription package, the customer may have discounted access to another report, but also must pay a subscription fee, such as a monthly or yearly membership. There is a need for a way to purchase updates without having to purchase an entirely new report.

The average small business customer buys about five reports a year. However, a few small business customers buy five reports a month and they are better off with a membership. The needs of most small business customers are low. There is a need for an inexpensive way to get the upside of having a membership with access to the most current information without a commitment for purchasing more than the small business customer needs.

Dun & Bradstreet provides many business information reports for small business customers, including a business information report (BIR), a comprehensive report, and a credit evaluator report. The customer who purchases one of these static reports receives delivery of an image, a printed report, a download, a display in an online archive, or a fax. With varying degrees of frequency, customers access one of these static reports again in the online archive during a pre-determined period of accessibility. Some customers buy a new report at the end of the period. Some buy a new report every year. There is a need for a customer to always have the most current information whenever the report is accessed with an attractive pricing scheme.

When a customer buys a static report with access at an online archive for a period of time, alerts are sent to the customer during the period with notification that a particular data element changed. This prompts the customer to go to a website and buy a new report. However, customers typically do not want to buy an entire new report for only a single piece of information that changed, without knowing what that change was. It was too hard of a decision without enough information. The present invention provides a service that optionally still includes alerts, but also automatically refreshes the altered data. In this way, the present invention allows the customer to find out what changed without having to buy an entirely new report only to find out that the changed or altered data is of little or no significance.

### SUMMARY OF THE INVENTION

A system and method of automatically updating business information reports that satisfies these and other needs.

In one embodiment the present invention includes a computer-implemented method for providing an automatically updated business information report to a customer having the steps of: updating daily a database of business information with newly available business information that is more current than that present in the database; generating a business information report in dependence on data retrieved from the database; storing the generated business information report for customer access; updating the business information report with data retrieved from the database that is more current than that presently contained in the business information report; the updating occurring upon each access of the business information report by the customer; and storing the automatically-updated business information report for further customer access.

In another embodiment the present invention includes a computer system for providing an automatically updated business information report to a customer having: a device for user input-output; an external memory having stored therein a business information database; a processor with internal memory operatively coupled to the input-output device and to the external memory; the internal memory has stored therein executable instructions for performing steps of: updating daily the business information database with newly available business information that is more current than that present in the database; generating a business information report in dependence on data retrieved from the database; storing the generated business information report for customer access; updating the business information report with data retrieved from the database that is more current than that presently contained in the business information report; the updating occurring upon each access of the business information report by the customer; and storing the automatically-updated business information report for further customer access.

This embodiment also includes executable instructions for performing, prior to the above step of generating, further steps of: displaying on the user input-output device an offer to sell one or more business information reports; receiving from the user input-output device a response to the displayed offer; and charging the customer for reports purchased if any, wherein only business information reports that were purchased are subsequently generated.

This embodiment also includes executable instructions for performing, prior to the above step of generating, further steps of: displaying on the user input-output device an offer to automatically update one or more already purchased business information reports for which automatic updates have not yet been purchased; receiving from the user input-output device a response to the displayed offer; charging the customer for automatic updates purchased if any, wherein only reports for which automatic updates were purchased are subsequently updated; and repeating the prior steps of displaying, receiving, and updating if there are any already purchased reports for which automatically update has not yet been purchased.

The embodiment also includes that the offer to sell one or more business information reports and the offer to automatically update one or more purchased business information reports are concurrently displayed on the user input-output device.

In another embodiment, the present invention includes a computer-readable medium for automatic update of a business information report having stored thereon executable instructions for performing steps of: updating daily a database of business information data with newly available business information that is more current than that present in the database; generating a business information report in dependence on data retrieved from the database; storing the generated business information report for customer access; updating the business information report with data retrieved from the database that is more current than that presently contained in the business information report; the updating occurring upon each access of the business information report by the customer; and storing the automatically-updated business information report for further customer access.

Aspects of all embodiments includes that the database of business information is updated with more than one million pieces of new information each business day; and that the business information report is selected from the group of business reports available from Dun & Bradstreet Corp consisting of a “business information report”, a “comprehensive report”, and a “credit evaluator report”.

### BRIEF DESCRIPTION OF THE DRAWINGS

These and other features, aspects, and advantages of the present disclosure will become better understood with reference to the following description, appended claims, and drawings where:

FIG. 1 is a screen shot of an example user interface that provides a selection of an automatic update service for a report;

FIG. 2 is a screen shot of the example user interface in FIG. 1, after a customer selects the automatic update service;

FIG. 3 is a screen shot of another example user interface that provides a selection of an automatic update service for a report;

FIG. 4 is a screen shot of another example user interface that provides purchase confirmation of an automatic update service for a report;

FIG. 5 is a screen shot of another example user interface that provides a selection of continued automatic update service;

FIG. 6 is a screen shot of another example user interface that provides a status of an automatic update service;

FIG. 7 is a logic flow diagram of an example method of providing an automatic update service for a report;

FIG. 8 is a block diagram of an example software architecture capable of providing an automatic update service; and

FIG. 9 is an exemplary computer system.

### DETAILED DESCRIPTION OF THE PREFERRED EMBODIMENTS

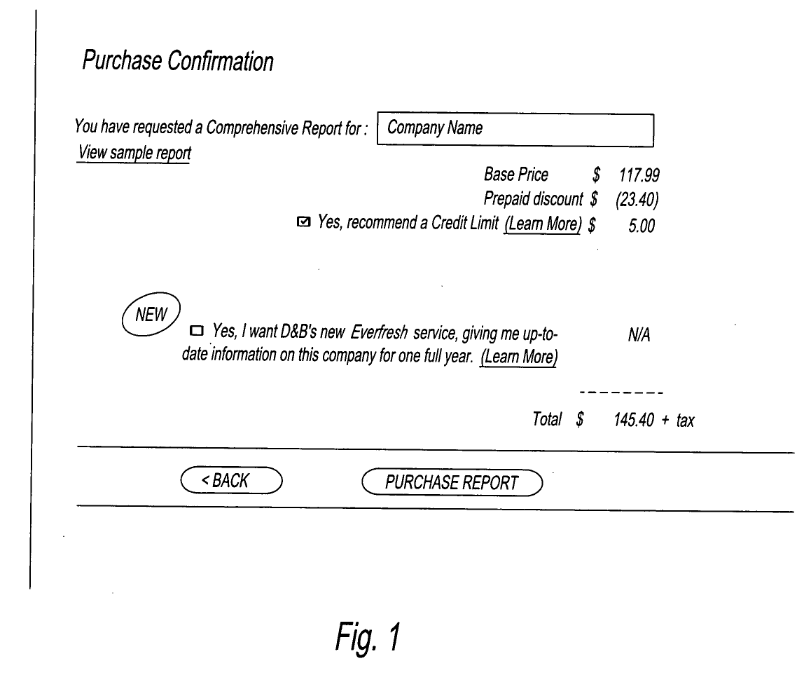

FIG. 1 shows an example user interface that provides a selection of an automatic update service for a report. In this example, when a comprehensive report is offered for purchase, the selection of the automatic update service is also provided. The automatic update service is capable of being offered for many different business information reports, such as those available from Dun & Bradstreet's Small Business Solutions, i.e., the business information report (BIR), the comprehensive report, and the credit evaluator report. The manner in which the automatic update service is offered is flexible and is capable of being customized to various user interfaces, such as a website, or any other customer delivery mechanism.

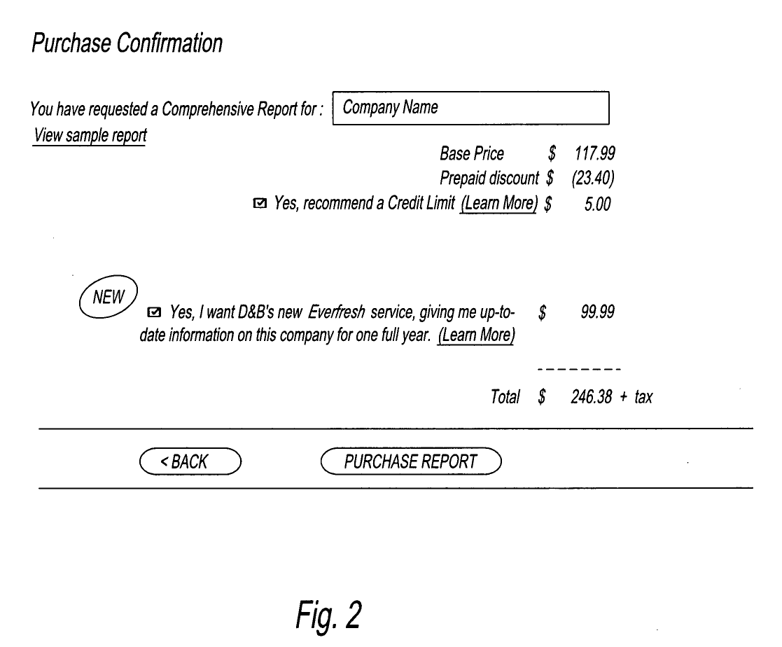

FIG. 2 shows the example user interface in FIG. 1, after a customer selects the automatic update service. In this example, the update service is offered for a price less than the price of the report itself and for a predetermined period of time, such as a year. There is “learn more” link text to educate the customer. Example customer education information is shown in Table 1 below.

TABLE 1
Sample Customer Education Information

New Auto-Refresh service
When you purchase Auto-Refresh service, your Credit eValuator,
Comprehensive, or Business Information report will be refreshed
automatically every time you view it for a full year. For a low
annual fee, Auto-Refresh alleviates the administrative burden of
manually tracking and monitoring the large volume of new
developments affecting companies you are watching.
The database is updated over 1 million times a day with new
information on company payment experiences, credit scores, address
and contact information, public filings, and financials. With Auto-
Refresh, you can be confident that you are receiving the most up-
to-date information available on the key companies that you track.
Simply select the Auto-Refresh option when you purchase a report,
or upgrade your report within 30 days of purchase. Once you have
purchased the Auto-Refresh service, simply access the Credit
eValuator, Comprehensive, or Business Information report on the
selected company and you will automatically receive the most up-
to-date report for a full year.

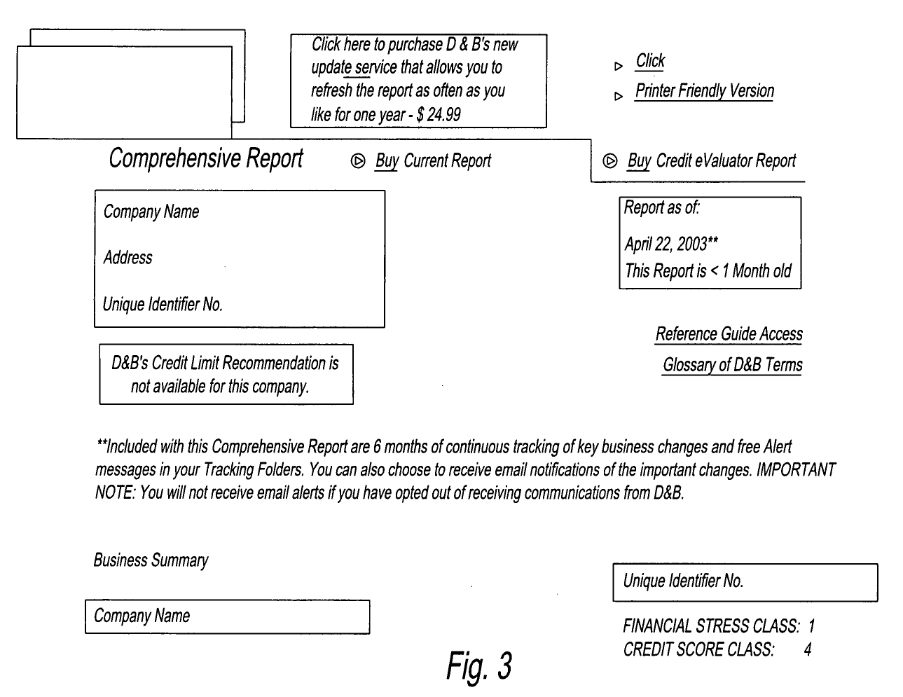

FIG. 3 shows another example user interface that provides a selection of an automatic update service for a report. In some embodiments, a message is sent to a customer when a report has been purchased without selecting the automatic updating service. For example, a message is sent thirty days after purchase. In other embodiments, a message directly on the report enables a customer to select the automatic updating service, such as a link. Preferably, the customer is reminded of the automatic update service at multiple points in time in association with a report. In one embodiment, messaging for the service is providing on a purchase report page that includes text describing the service and a check box that the customer uses to select the service. Any method of selection, such as highlighting or clicking a picture or link may be used. Selecting the check box activates scripts that display the price for the service and increments the total price.

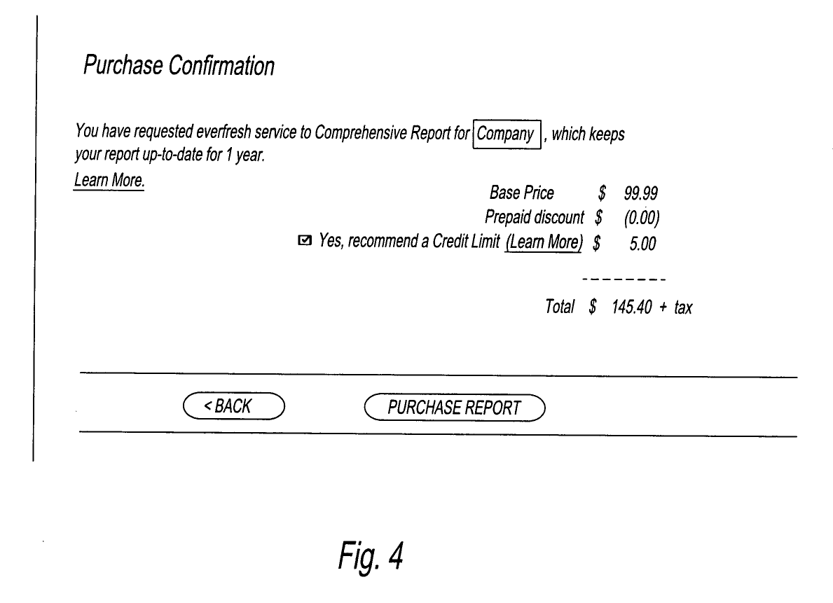

FIG. 4 shows another example user interface that provides purchase confirmation of an automatic update service for a report. Messaging about the automatic update service is also provided on the report itself, thirty days after the customer purchased the report in a small message box having a link for selection. Upon selection of the link, the purchase confirmation screen is displayed.

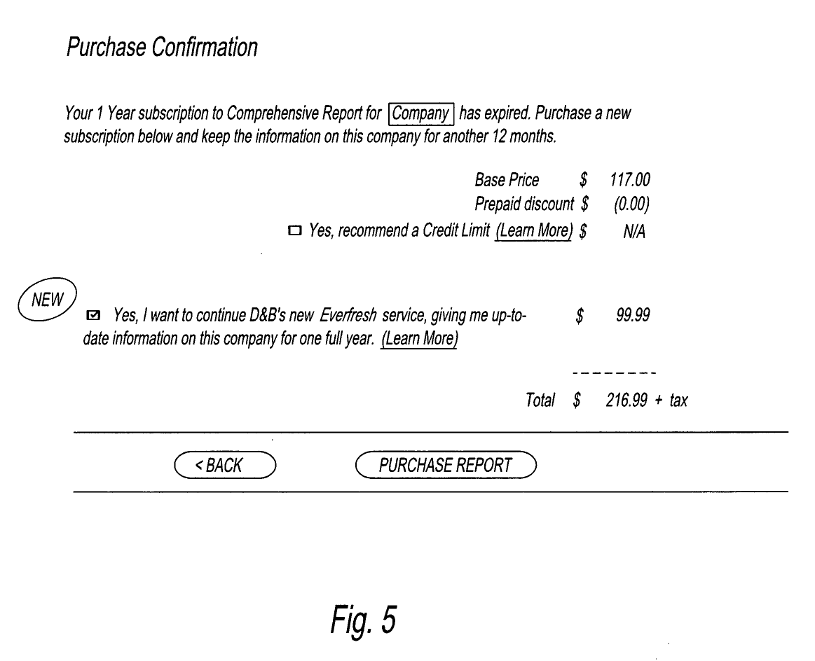

FIG. 5 shows another example user interface that provides a selection of continued automatic update service. A method of providing renewal of the automatic update service includes notifying customers that the service is about the expire.

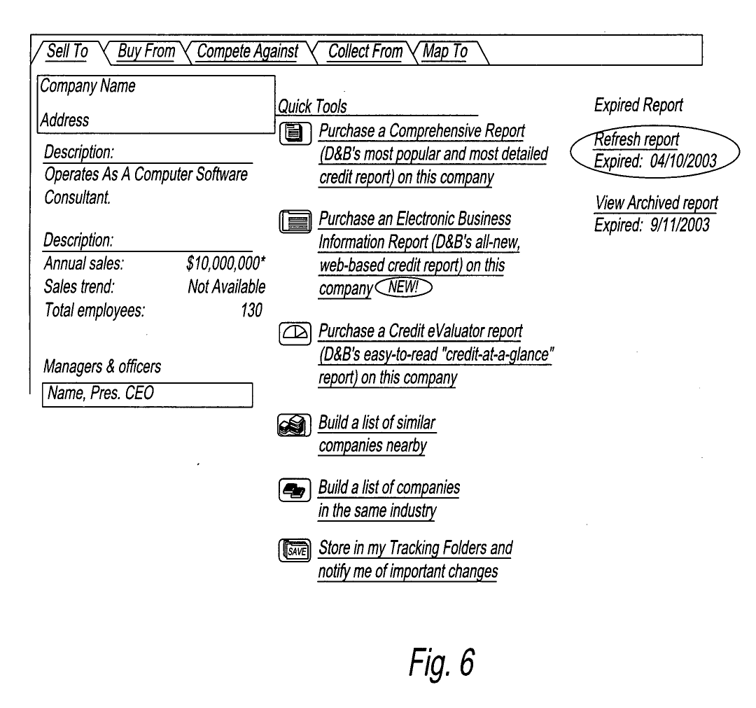

FIG. 6 shows another example user interface that provides a status of an automatic update service. In one embodiment, just a week prior to the service expiration, the customer is sent an automatic login based email message notifying them of the pending expiration. The message includes a link in the body to drive the customer back to the website into an area that enables them to purchase the report once more and extend the automatic update service. In another embodiment, when the customer attempts to access the report, user interface includes an indication that the automatic update service has expired. This indication includes text and a link, which is preferably substantially similar to the email message notification. This link drives the customer to repurchase the automatic update enabled report. Upon selection, the purchase confirmation screen is displayed with the checkbox for selecting the service already checked.

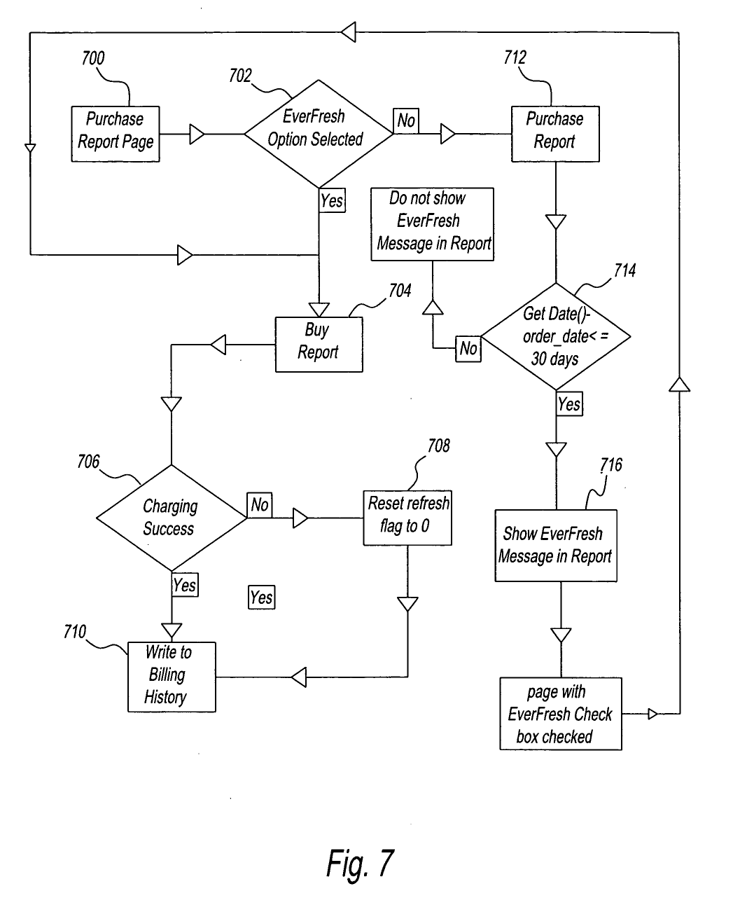

FIG. 7 shows an example method of providing an automatic update service for a report. In step 700, a purchase report page is displayed. It is determined whether the customer selects the automatic update service 702. If so, control flows to step 704, where the customer buys the report with the update service and billing is performed in steps 706, 708, and 710. If the customer does not select the automatic update service in step 700, control flows to step 712. In step 712, the customer buys the report. Then, in step 714, it is determined when thirty days from the date of purchase occurs. After thirty days have elapsed, a message about the automatic update service is sent to the customer in step 716. In step 718, the customer follows a link in the message to a website and to purchase the automatic update service and buys it in step 704.

There are at least three purchase flows. A first purchase flow is when the customer searches for a company and buys a report, selecting automatic update service. A second purchase flow is when the customer has bought a report and selects the automatic update service from a link in the report. A third purchase flow is renewal after email notification of pending expiration of automatic update service or after notice after attempting to access an expired report.

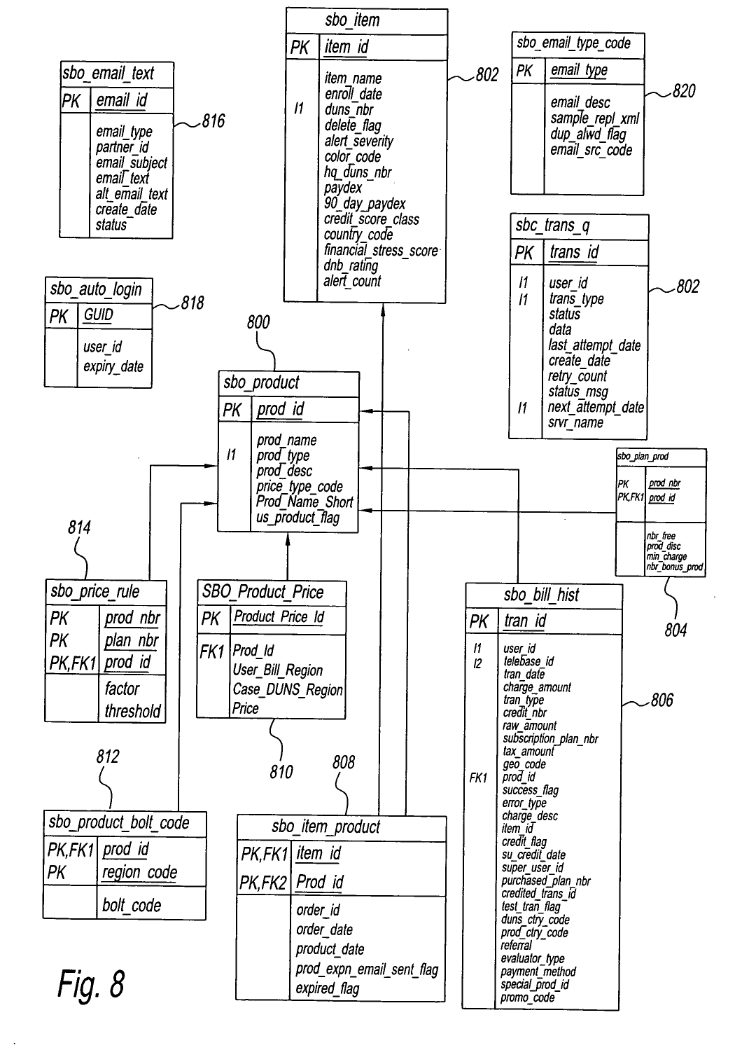

FIG. 8 shows an example software architecture capable of providing an automatic update service. In an example embodiment, sbo_product 800 has a primary key of product identifier and fields for product name, product type, product description, price type code, short product name, and a U.S. product flag. Sbo_product 800 is related to tables sbo_item 802, sbo_plan_prod 804, sbo_bill_hist 806, sbo_item_product 808, sbo_product_price 810, sbo_product_bolt_code 812, and sbo_price_rule 814. Other tables include sbo_email_text 816, sbo_auto_login 818, abo_email_type_code 820, and sbo_trans_q 822. These form a data model and are used to provide the automatic update service, along with various other components. The example system for providing an automatic update service includes the data model. Sbo_item_product 808 includes columns for refresh flags, refresh dates, and expiration dates. Sbo_product_service includes product identifiers and service product identifiers for reports and automatic update service.

In this example embodiment, a three tier application architecture is used to implement the service. Various software components perform methods of providing the automatic update service.

An example method of processing changes to a buy a credit evaluator report is represented by the pseudo code in Table 2 below.

TABLE 2
Pseudo code for an example method of processing
changes to buy a credit evaluator report.

Public Function BuyEvaluator ( )
If ReportExists & oEvalInfo.bEverFreshFlag = True

Do not Charge
Update Refresh Date

Else
Normal flow
End if
End Function

An example method of processing changes to a buy comprehensive report is represented by the pseudo code in Table 3 below.

TABLE 3
Pseudo code for an example method of processing
changes to buy a comprehensive report.

Public Function BuyRetailReport ( )
If ReportExists & oRptInfo.bEverFreshFlag = True

Do not Charge
Update Refresh Date

Else
Normal flow
End if
End Function

An example method of updating refresh flags, refresh dates, and expiration dates is represented by the pseudo code in Table 4 below.

TABLE 4
Pseudo code to an example method of update refresh
flags, refresh dates, and expiration dates.

Update sboInsertItem stored procedure and sboUpdateitem stored
procedure:
If refresh_flag=1 and prod id 1

Expiry_days = 12 months

Else if prod id = 1
Expiry_days = 6 months
More conditions will be added for other products
End if

Use the expiry_days value to update the expiration_date column

An example method of providing renewal email messages includes determining when automatic update service is expiring for a customer in a predetermined period of time, such as a week before expiration. To prepare the email message, a text file with email text is loaded. Extensible markup language (XML) is prepared and loaded to sbo_email_type_code and sbo_email_text table using loadMailToDB.vbs. The pseudo code in Table 5 below is for PromoEmail.vbs.

TABLE 5
Pseudo code for PromoEMail.vbs.

oEverFreshUsers = Pick all EverFresh expiry users
Do Loop for All oEverFreshUsers

cUser.InsertAutoLogin ( ) Update AutoLogin table with URL
Prepare URL (AutoLogin Link)
Call sendEverFreshExpiryEmail( )

End loop
Function to send email for EverFresh Service renewal users.
Public sub sendEverFreshExpiryEmail ( )

Prepare Email Text
Call oFusTrans.insertEmail2intoQ ( )

End sub

Alternate embodiments provide a sales message at various times to get the maximum response rate. Some embodiments provide a sales message in a purchase confirmation page. Other embodiments, promote the automatic update service in various parts of a website providing business information. For example, one embodiment provides selection of the automatic update service when the customer views the shopping cart, along with other options that are available. Other embodiments, promote the automatic update service after a sale. For example, providing a link on a data product for customer selection in various contexts, such as product description pages, shopping carts, and on the product itself.

Preferably, there is an end-to-end service for the customer. The customer goes to a website, conducts a search on a business, buys a report, stores the report in an archive or tracking folder, and has current information served in the report for a predetermined period of time, such as a year. The customer may access the website from a handheld device, a desktop computer, or any other computing device. The report may be delivered in hypertext markup language (HTML), XML, PDF, by fax, or any other tangible or intangible medium. Updates may be provided in many ways, including new reports, indications of what data has changed, delta files, and the like. An end-to-end service ensures current business information for making business decisions. The customer receives business information that is more current, in addition to being broader and more in depth than conventional business information services

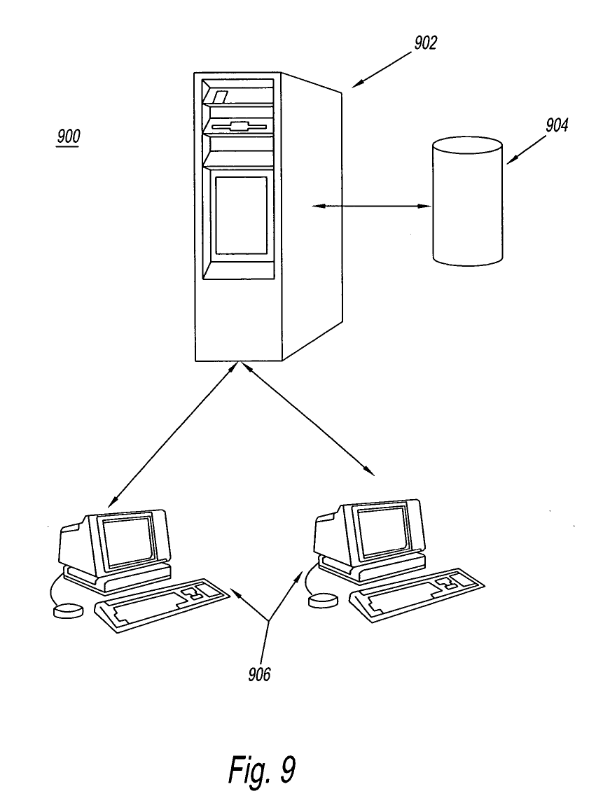

FIG. 9 illustrates an exemplary computer system which can perform the methods of this invention. Computer system 900 includes processor and internal memory 902, external database memory 904, and user input-output devices 906. The internal memory has stored therein executable instructions for causing the system to perform the methods of this invention. These executable instructions can be initially loaded from portable computer-readable media, such as optical disks, magnetic tape, and so forth, which can store instructions for performing any combination of the methods of this invention. The external data base memory has stored therein databases accessed by the methods of this invention; the databases can be structured as, for example, is illustrated in FIG. 8.

It is to be understood that the above description is intended to be illustrative and not restrictive. Many other embodiments will be apparent to those of skill in the art upon reviewing the above description, such as adaptations of the present disclosure to many different kinds of business information reports, mailing lists, delta files, and other database driven data products. Various designs using hardware, software, and firmware are contemplated by the present disclosure, even though some minor elements would need to change to better support the environments common to such systems and methods. The present disclosure has applicability to various business information services, and extends beyond the example embodiments described, such as various credit products, marketing products, and business information research products. Therefore, the scope of the present disclosure should be determined with reference to the appended claims, along with the full scope of equivalents to which such claims are entitled.

What is claimed is:

1. A computer-implemented method for providing an automatically updated business information report to a customer, the method comprising:
updating daily a database of business information with newly available business information that is more current than that present in the database;
generating a business information report in dependence on data retrieved from the database;
storing the generated business information report for customer access;
updating the business information report with data retrieved from the database that is more current than that presently contained in the business information report; the updating occurring upon each access of the business information report by the customer; and
storing the automatically-updated business information report for further customer access.

2. The method of claim 1 wherein said database of business information is updated with more than one million pieces of new information each business day.

3. The method of claim 1 wherein the business information report is selected from the group of business reports available from Dun & Bradstreet Corp consisting of a “business information report”, a “comprehensive report”, and a “credit evaluator report’.

4. The method of claim 1 further comprising, prior to the step of generating the business information report, a step of displaying an offer that the business information report is available for purchase.

5. The method of claim 4 further comprising a step of receiving a response to the displayed offer, wherein the business information report is generated only if the response indicates purchase of the business information report.

6. The method of claim 1 further comprising, prior to the step of updating the business information report, a step of displaying an offer that automatic update of the business information report is available for purchase.

7. The method of claim 6 wherein a selectable indicia is displayed on the business information report, the selection of which causes the display of the offer that automatic update is available for purchase.

8. The method of claim 6 wherein the step of displaying comprises sending, at the time the business information report is purchased, a message to the customer that displays the offer that automatic update of the business information report is available for purchase.

9. The method of claim 6 wherein the step of displaying comprises sending, a selected number of days after the business information report is purchased, a message to the customer that displays the offer that automatic update of the business information report is available for purchase.

10. The method of claim 6 further comprising a step of receiving a response to the displayed offer, wherein the business information report is updated only if the response indicates purchase of automatic update.

11. The method of claim 10 wherein automatic updating is purchased for a fixed period of time, and further comprising a step of displaying that automatic updating of the business information report will expire and/or has expired.

12. The method of claim 10 further comprising a step of displaying an offer that renewal of automatic update of the business information report is available for purchase, wherein the business information report is subsequently updated automatically only if the response to the display offer indicates purchase of renewal of automatic update.

13. A computer system for providing an automatically updated business information report to a customer, the system comprising:
a device for user input-output;
an external memory having stored therein a business information database;
a processor with internal memory operatively coupled to the input-output device and to the external memory, wherein the internal memory has stored therein executable instructions for performing steps comprising:
updating daily the business information database with newly available business information that is more current than that present in the database;
generating a business information report in dependence on data retrieved from the database;
storing the generated business information report for customer access;
updating the business information report with data retrieved from the database that is more current than that presently contained in the business information report; the updating occurring upon each access of the business information report by the customer; and
storing the automatically-updated business information report for further customer access.

14. The system of claim 13 wherein the executable instructions are for performing, prior to the step of generating, further steps comprising:
displaying on the user input-output device an offer to sell one or more business information reports;
receiving from the user input-output device a response to the displayed offer; and
charging the customer for reports purchased if any, wherein only business information reports that were purchased are subsequently generated.

15. The system of claim 14 wherein the executable instructions are for performing, prior to the step of updating the report, further steps comprising:
displaying on the user input-output device an offer to automatically update one or more already purchased business information reports for which automatic updates have not yet been purchased;
receiving from the user input-output device a response to the displayed offer;
charging the customer for automatic updates purchased if any, wherein only reports for which automatic updates were purchased are subsequently updated; and
repeating the prior steps of displaying, receiving, and updating if there are any already purchased reports for which automatically update has not yet been purchased.

16. The method of claim 15 wherein the offer to sell one or more business information reports and the offer to automatically update one or more purchased business information reports are concurrently displayed on the user input-output device.

17. The method of claim 13 wherein the database of business information is updated with more than one million pieces of new information each business day.

18. A computer-readable medium for automatic update of a business information report having stored thereon executable instructions for performing steps comprising:
updating daily a database of business information data with newly available business information that is more current than that present in the database;
generating a business information report in dependence on data retrieved from the database;
storing the generated business information report for customer access;
updating the business information report with data retrieved from the database that is more current than that presently contained in the business information report; the updating occurring upon each access of the business information report by the customer; and
storing the automatically-updated business information report for further customer access.

19. The computer-readable medium of claim 18 wherein the executable instructions are for performing, prior to the step of generating, further steps comprising:
displaying on a user input-output device an offer to sell one or more business information reports;
receiving from the user input-output device a response to the displayed offer; and
charging the customer for reports purchased if any, wherein only business information reports that were purchased are subsequently generated.

20. The computer-readable medium of claim 19 wherein the executable instructions are for performing, prior to the step of updating the report, further steps comprising:
displaying on the user input-output device an offer to automatically update one or more already purchased business information reports for which automatic updates have not yet been purchased;
receiving from the user input-output device a response to the displayed offer;
charging the customer for automatic updates purchased if any, wherein only reports for which automatic updates were purchased are subsequently updated; and
repeating the prior steps of displaying, receiving, and updating if there are any already purchased reports for which automatically update has not yet been purchased.

21. The computer-readable medium of claim 20 wherein the offer to sell one or more business information reports and the offer to automatically update one or more purchased business information reports are concurrently displayed on the user input-output device.

22. The computer-readable medium of claim 19 wherein the database of business information is updated with more than one million pieces of new information each business day.

23. The computer-readable medium of claim 19 wherein the business information report is selected from the group of business reports available from Dun & Bradstreet Corp consisting of a “business information report”, a “comprehensive report”, and a “credit evaluator report”.
